(19) United States
(12) Patent Application Publication
(10) Pub. No.: US 2014/0171734 A1
(43) Pub. Date: Jun. 19, 2014

(54) PALLIATIVE SUPPORT DEVICE

(71) Applicant: Leon B. KASSMAN, Rockville Center, NY (US)

(72) Inventor: Leon B. KASSMAN, Rockville Center, NY (US)

(21) Appl. No.: 13/717,989

(22) Filed: Dec. 18, 2012

(51) Int. Cl. A61H 19/00

(52) U.S. Cl. CPC A61H 19/50
USPC 600/38

(57) ABSTRACT

A palliative device includes a body sized and shaped to form a sleeve extending longitudinally on a penis. The body includes chambers that can be pressurized from an external fluid source to selectively expand and contract the body radially.

### BACKGROUND OF THE INVENTION

a. Field of the Invention

This invention relates to means that assist in developing and maintaining erections and providing stimulation for both male and female genitalia. More particularly, the invention pertains to a palliative device having a body that forms a sleeve or a wrap, the body including sections or chambers that are radially and simultaneously expanded inwardly toward the penis and outwardly in the direction that would correspond to the vaginal walls or surfaces proximal to the vaginal cavity when the device is used during sexual intercourse, preferably by selectively pressurizing the same with a fluid t present therein or pr selelctively introduced from an external source into the chambers.

b. Description of the Prior Art

Aided by the maturation of global societies, a trend associated with more open sexuality has developed. This trend allied to the similarly evolving trend toward healthier life-styles that lead to longer lives allows men and women to enjoy a longer and more active sex life. Another trend toward openness or frankness of expression has allowed people everywhere to experience greater conventional male-female sexual contacts along with male-male/female-female interactions. Additionally, former societal taboos on masturbation and other experimental forms of individual expressions have relaxed as witnessed by the near phenomenal growth of the individual sex-toy industry.

Contrasted with these sociological and psychological trends is the availability of medications designed to counteract both the normal effects of aging on blood vessels and the effects of ingesting blood-vessel clogging processed fast-food. These medications and other targeted chemical preparations enable, at least per their advertising, even longer more active sex lives. A concomitant sociological trend that has caused changes in sexual activities is the increasing number of divorces. When former spouses return to singlehood, many, at least from time to time, lose easy accessibility to interpersonal sex. During those times, the learned ability to pleasure ones' self, using any number of sexual techniques, becomes operant. This invention adds sophistication to some of those chosen techniques by permitting the instruments to deliver stimulation more closely related to the stimulation one might anticipate from a partner than from the careful manipulation of a device alone. This invention extends the use of those devices by allowing them to feel more like the ‘real thing’.

Unfortunately, the side-effects of aging and some of these medications/practices creates lowered libido and unstable blood pressures, which only complicates the sex drive and the ability to maintain erectile functioning or, in females their natural vaginal lubrication. As a means of ameliorating the resulting problems, a series of palliative treatments have been developed. This invention focuses primarily on the treatments for the male partner. However, due to its stimulative characteristics, the invention may be used to stimulate female erogenous zones as well, and thus the invention may be considered to be ‘cross-sexual’.

These treatments, as directed toward erectile functioning, include the well know prescriptive medications such as Viagra®, Levitra®, and Cialis® along with various mechanical devices such as urethral inserts, penis injections, penile-implants and vacuum pumps. These provide variable benefits depending on the nature of the underlying erectile dysfunction and the man's tolerance for minor or severe interventions.

Each of these treatments requires the introduction of a chemical, an operative/medical procedure, or the forced engorging of blood into the penis using some kind of pumping action that creates an external vacuum around the penis. Injections and trans-urethral inserts deal with the erection directly and use this invasive chemical means to simply support and enhance whatever ability a man might have to produce and sustain an erection. None of these external treatment options provide continued physical support throughout the sex act although the vacuum model calls for a compressive ‘cock ring’ to be rolled onto the penis base so that previously engorged fluids are retarded from returning to the body. None contribute directly to the pleasure centers of the man. None are designed to specifically interact with the pleasure centers of a woman. None are essentially instantly active. And, none-will work universally regardless of the extent of erectile dysfunction. Finally, none can be used repeatedly achieving their designed effect, time after time, even in a very short interval of time—within the normal male's refractory period. Importantly, Not one can advertise that it has no side effects.

The prior art is filled with many inventions designed to achieve a safer and more pleasurable sexual experience. In addition to conventional condoms or condoms with wider glans area, there are several designs for condoms with rings or studs that are molded directly into the condom body. There are condoms which use air to inflate a series of lateral and circumferential tubules and several of these rely on air or fluids introduced externally under pressure to achieve compressive force on the penis and, in turn, aid in the erectile maintenance.

The patents with related subject matter include Johnson U.S. Pat. No. 7,678,042, Winkler, U.S. Pat. No. 5,954,054, Lytle, et al. U.S. Pat. No. 5,422,240, Rudge et al, U.S. Pat. No. 6,491,035, Osterberg, U.S. Pat. No. 6,233,747, Winkler, U.S. Pat. No. 5,954,054, Johnson, U.S. Pat. No. 7,678,042”, Oldham et al, U.S. Pat. No. 6,074,671, Michelson U.S. Pat. No. 6,983,751, Manning U.S. Pat. No. 6,370,694, Michelson, U.S. Pat. No. 6,175,962, (Jackson—U.S. Pat. No. 3,116,110), Squicciarini, U.S. Pat. No. 7,527,589, Dykers Jr, U.S. Pat. No. 7,377,896, Ausing U.S. Pat. No. 7,047,975, Bergeron, et al. U.S. Pat. No. 7,192,607, Moench, et al. U.S. Pat. No. 7,316,232, Tam U.S. Pat. No. 7,322,358, Duncan, U.S. Pat. No. 3,545,439; Roseman, U.S. Pat. No. 3,920,805; Schopflin, U.S. Pat. No. 4,012,496 and U.S. Pat. No. 4,012,497; Wong et al., U.S. Pat. No. 4,237,885 and U.S. Pat. No. 4,286,587; and Nash et al., U.S. Pat. Nos. 4,292,965, 5,715,839, 6,135,112, 6,298,852, 5,954,054, 5,715,839, 6,135,112 Strauss, Wulf, U.S. Pat. No. 6,319,194 Penis Stabelizer, Shah, et al. U.S. Pat. No. 6,460,541 and U.S. Pat. No. 6,805,662. In U.S. Pat. No. 594,815 to Taggart, U.S. Pat. No. 1,511,572 to Marshall, U.S. Pat. No. 2,018,328 to Smith, U.S. Pat. No. 2,581,114 to Larson, U.S. Pat. No. 2,818,855 to Miller, U.S. Pat. No. 3,401,687 to Hood, U.S. Pat. No. 3,621,840 to Macchioni, U.S. Pat. No. 3,705,580 to Gauthier, U.S. Pat. No. 4,224,933 to Relling, U.S. Pat. No. 4,529,980 to Chaney, U.S. Pat. No. 4,723,538 to Stewart et al. and U.S. Pat. No. 5,282,795 to Finney different types of male erection devices are described.

The devices include elastic rings, surgical devices and sexual aids for constricting blood flow from the male penis and helping with impotency include the following U.S. Pat. No. 3,939,827 February 1976 Fenstetter, U.S. Pat. No. 4,432,357 February 1984 Pomeranz, U.S. Pat. No. 4,564,006 January 1986 Pomeranz, U.S. Pat. No. 5,823,939 October 1998 Tsagarakis, U.S. Pat. No. 6,193,753.

Wulf, U.S. Pat. No. 6,319,194, describes a penis erection stabilizer adapted for mounting on the base of a male penis designed to apply harmless pressure around the circumference of the penis via and may be composed of filled or partially filled channels which distend (even partially) the substrate use to form them and which helps trap a blood supply in the penis thus resulting or assisting in creating and maintaining a bigger, longer lasting natural erection during sexual intercourse. He also defines a stretchable elastic outer ring or cuff or sleeve component used to create biohematohydraulics', or more literally, body blood liquid hydraulic pressure and force within the shaft of the penis erectile tissue.

Kassman's patents (U.S. Pat. Nos. 5,885,205, 6,569,083) and a patent by Nordheim (U.S. Pat. No. 6,193,753) describe a fluid (air) deriving from an external source that is used to expand one or more tubules within a device that is placed on the penis. A single fluid is used. There is a single direction for the fluid from the outside to the inside of the device without any return. There is no provision for more than one fluid at one time. There is no provision for cycling any fluids. There is no provision for creating vibrational movement in the fluids once they are introduced. There are no mechanical provisions of the device itself other than the amount of fluid expansion once the fluid is infused to per the device to be adjusted for different sized penises.

The present invention not only provides for different values of compressive energy, it causes the compression it varies to be perceived as movement against the skin of the penis, the clitoris and the vaginal vault surfaces contacted as if in addition to normal in and out intermissive strokes, both the penis and the vaginal feel as though fingers are present causing similar kinds of manipulations as might commonly be used in masturbation.

U.S. Patent Application 20070186935 discloses a coition activated inflatable reservoir condom.

### SUMMARY OF THE INVENTION

The present invention mechanically achieves provides an improvement over existing mechanical devices and provides additional benefits that are not available from the other treatments. It is designed to be ‘worn’ and used throughout the sex act. The moment it is needed, its design permits it to be easily activated; only donning is necessary. Additionally, there are no negative side-effects from using the invention. The invention will be widely available very inexpensively, at roughly at the same cost of a pack of conventional condoms. Indeed the invention may be used, optionally, with a condom—either with the condom on top of the invention, or with the invention applied directly against the skin of the penis and then a condom is applied over it. The invention can be manufactured to be either reusable (preferably after soaking in a microbicide solution) or disposable after a single use. Further, the invention may or may not be used in either heterosexual or homosexual interaction or it may be used exclusively to enhance masturbatory sex when applied to an object purchased for stimulation.

The present invention achieves an ideal status as an erectile assistive device in that it may be used instantly as needed: it will fit every man, it is easy to use, economical, safe and non-invasive. It will appeal to men and to women, and to heterosexuals and homosexuals alike. Women may use the device independently by applying it to tubular devices such as a dildo or other objects that are used as a dildo. The invention's characteristic expansion chambers and the movement within those chambers when connected to the inventions peristaltic or diaphragm pump will produce sensations similar to and more targeted at erogenous zones than would be available during conventional coitus. Alternatively, the device may be used by itself, without any additional elements.

The present invention supports a full or partial erection throughout the sex act and, additionally can perform as an artificial erection—all with the benefit of maintaining the ability for ejaculation.

The present invention uses a support sleeve or wrap configuration that wraps around or surrounds the penis in the area between the glans and the base of the penis. In essence, due to the different lengths available, it encompasses the entire, erect or non-erect penile shaft below the glans. This results in uniform support through controlled fluid induced compression without the type of constriction that can cause damage to the penis (e.g.,—when the constriction is in the form of a hardened rubber ring that is rolled into place at the base of the penis.) The device is then inflated with air, a saline solution or other non-toxic fluid (which may or may not be compressible) to cause within the defined spaces of the at least one but possibly multiple inter-woven tubule networks both circumferential and lateral (e.g. tangential and/or radial) compression, generating a torque which is transferred naturally to the ambient fluids and malleable tissues within the penis resulting in penile rigidity imitating the same action as caused by actual blood flow and engorging. Plastic inserts may or may not be used within the body of the invention to further add longitudinal stability.

The invention may be inflated by an externally applied (and potentially removable) air-source such as an inflation bulb, external or internal thumb-pump using an air-engorging cellulose/memory foam/rubber filled or chamber, an external detachably-attached compressed air source, or a small air pump (peristaltic or diaphragm) capable of variably infusing one or more fluids using any series of pressure cycles. Such cyclic action maybe controlled by the user through activating an external infusion source, or through an intermediary programmable IC chip or as a function of previously designed action that became a component of the pumps themselves.

Another application for this device may be an assist for incontinence. After intercourse the invention may be easily removed and either disposed of or cleaned in a safe and sanitary manner.

### BRIEF DESCRIPTION OF THE DRAWINGS

FIG. 1 is a side view of the invention showing expandable pockets, infusion tubes and an articulating pump.

FIG. 2 is a view of a cross-cut network of expansion tubules and a view of the expandable movement of the invention pleasure sleeve.

FIG. 3 is a view of an invention iteration showing the adjustable overlap closure on a wider tubule infusion network

FIG. 4 is a side view of the invention configured in a columnar expansion network with a compressed air pellet serving as the source of air infusion.

FIG. 5 is a side view of wider tubule network fitted with an excitement enhancer cap to bring compressive and stimulating movement directly to the glans of the penis.

FIG. 6 A,B,C show a partial enlarged side view, a full side view and a top view of a flat configuration of an embodiment composed of a single sheet having mechanically detachably longitudinal edges; and

FIGS. 7, 7A, 7B1, 7B2 and 7B3 show another embodiment of the invention where a sealable pocket (95) is created between the substrate laminates of body (12) to extend approximately at least 15 degrees around the arc or the invention's body.

### DETAILED DESCRIPTION

Referring now to the drawings, the present invention provides a palliative device 10 having a main body 12 that has the shape of a sleeve. The main body 12 is preferably made of polymers that may be porous, nonporous, and or manufactured from solid and absorbent materials either singularly and in combination with such materials as sponges (soft and hard), cloth, synthetic cloth, cotton, plastic, plastic composites, rubber, latex, and polyurethane. Two or more similar substrates may be joined together and joining at least one part using any conventional bonding such as heat sealing, ultrasonic welding, radio frequency sealing, adhesives or other similar joining means.

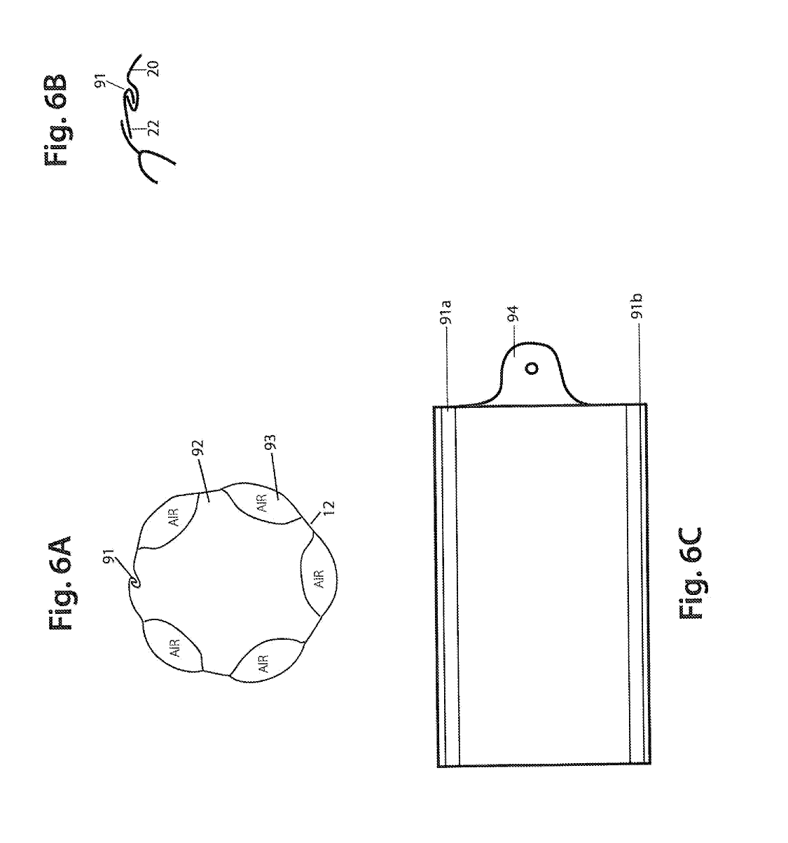

The main body 12 may be i partitioned into a plurality of chambers 14 in fluid communication with a plurality of respective tubes 16. Introducing fluid into the tubes forms a variously and serially inflatable panels 18 either individually, in a predetermined grouping, or simultaneously, and either in unison or in a pre-determined order. The body 12 may be made as at least a single flat element with two end panels 20, 22 that may or may not be joinable one to another by using any conventional joining or bonding technology, which itself may or may not be a permanent attachment or a detachable attachment. Alternatively the edges or, even, the extended panel may be manufactured or fitted post manufacture with a detachably-attachable hook system as shown in FIG. 6A, 6B, 6C.

One end panel (e.g. 20) may be provided with Velcro® hoops and the other end panel may be provided with Velcro® loops. The body 12 is then preassembled by overlapping and interlocking the two end panels 20, 22 and the body is donned or pulled over the penis. Alternatively, the body 12 is manufactured as a continuous tube that is slipped over the penis and employs the fluid introduced into its chamber network (14), which expand with that fluid to grip the shaft of the penis. Furthermore, in configurations where there are two substrates joined to comprise the body (12), those substrates may be chosen with different coefficient of elasticity and with different durometer thus causing a weaker or tighter grip on the penis when the fluid is infused.

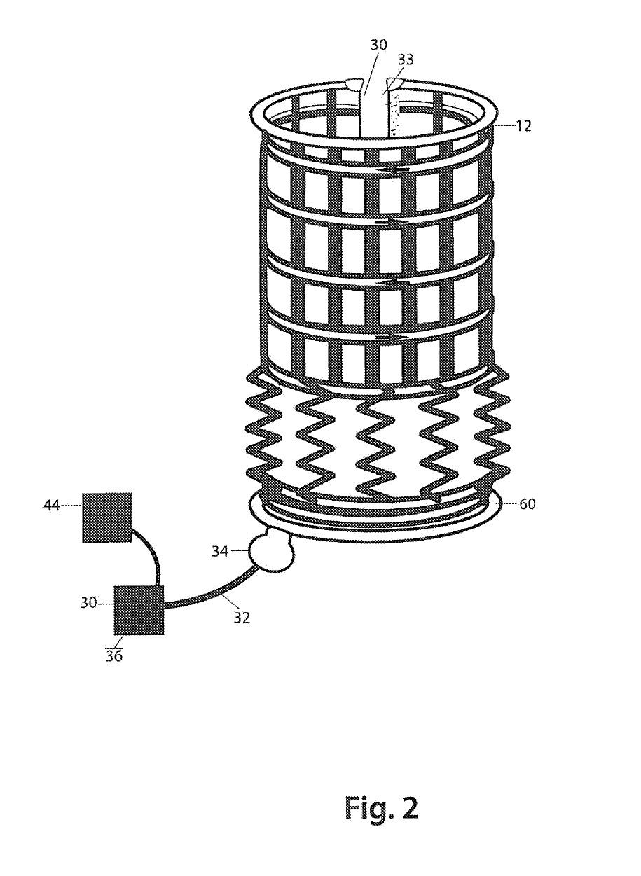

Depending on its dimensions, the body 12 either overwraps the penis or partially wraps it so that a longitudinal portion of the penis is not covered by body 12, as shown in FIG. 2. The body may be at least 2′; in length but may be manufactured in longer lengths as the market or different anatomical characteristics in different sub-populations might prescribe. Any working diameter of the tube configuration would be at least ¾″ in diameter and may be as wide as 3″.

A pump, which may be a peristaltic, diaphragm, electronic or bellows type, and may be assembled to an electronic control board 30 is connected by an inlet pipe 32 and a check valve 34 to the tubes 16. The pump 30 may be connected to a conventional power supply or may be provided with internal batteries (not shown). A control switch 36 mounted on the pump or elsewhere is used to actuate the pump causing it introduce air or other fluid into the tubes 16 and chambers 14. An optionally inserted outlet valve 38 is used to selectively discharge the fluids from the pipes 16 and chambers 14 for those devices that do not feature a closed (continuous) loop, internal system but rely on introducing fluids from an exterior source or reservoir.

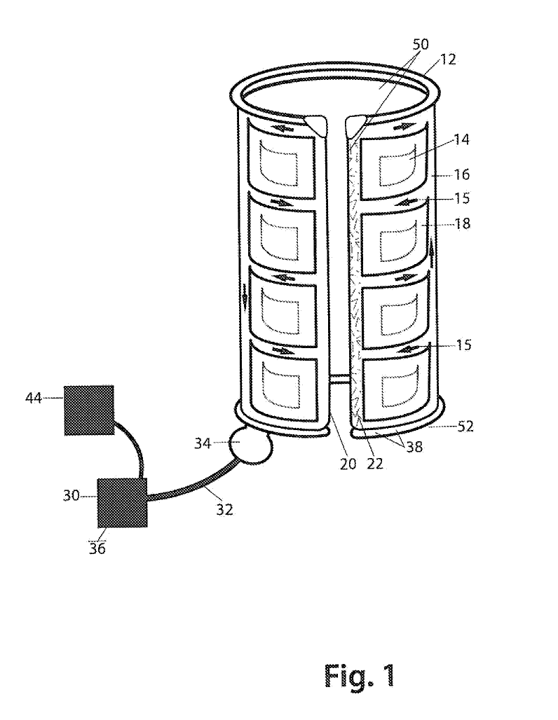

FIG. 1 shows body 12 formed of a plurality of chambers 14 arranged in an array and selectively inflated (e.g., through a connection 15 by tubes 16).

FIG. 2 shows an alternate embodiment wherein a lower portion 12A is shaped like a bellows Co form a flexible, variable length extension joint 60.

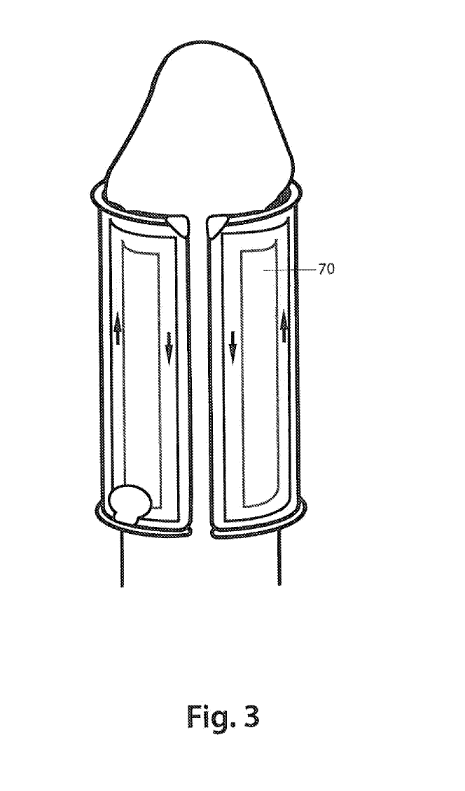

FIG. 3 shows an embodiment in which a plurality of longitudinal chambers 70 are provided, the chambers being selectively pressurized from a fluid source.

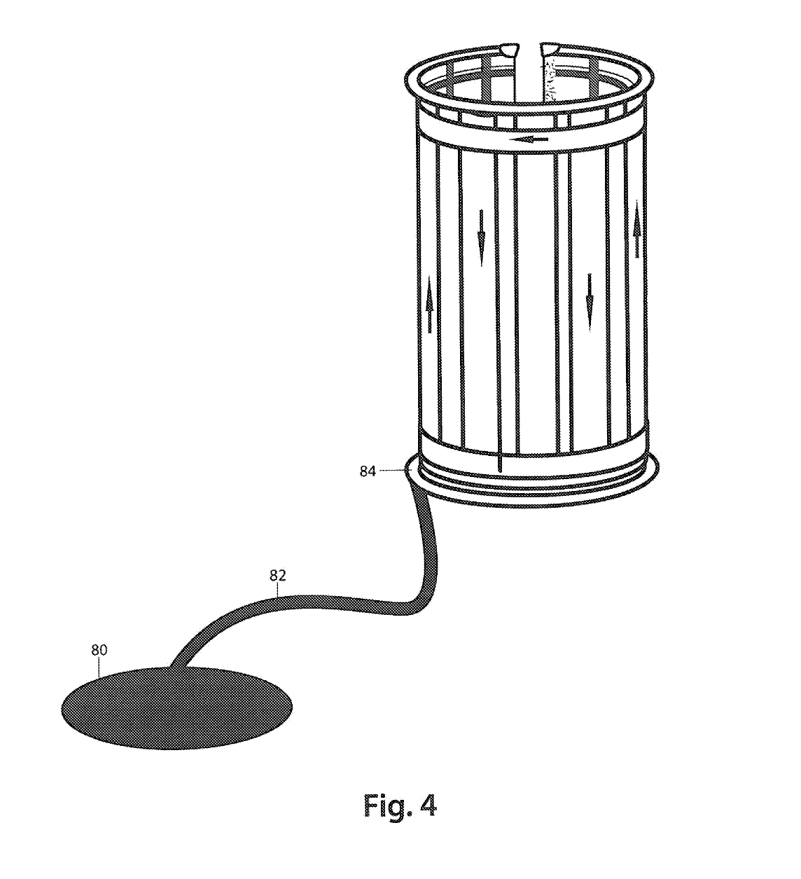

FIG. 4 shows another embodiment in which a compressed air pellet 80 is connected by inlet 82 and pressurizes the chambers/tubes of the body.

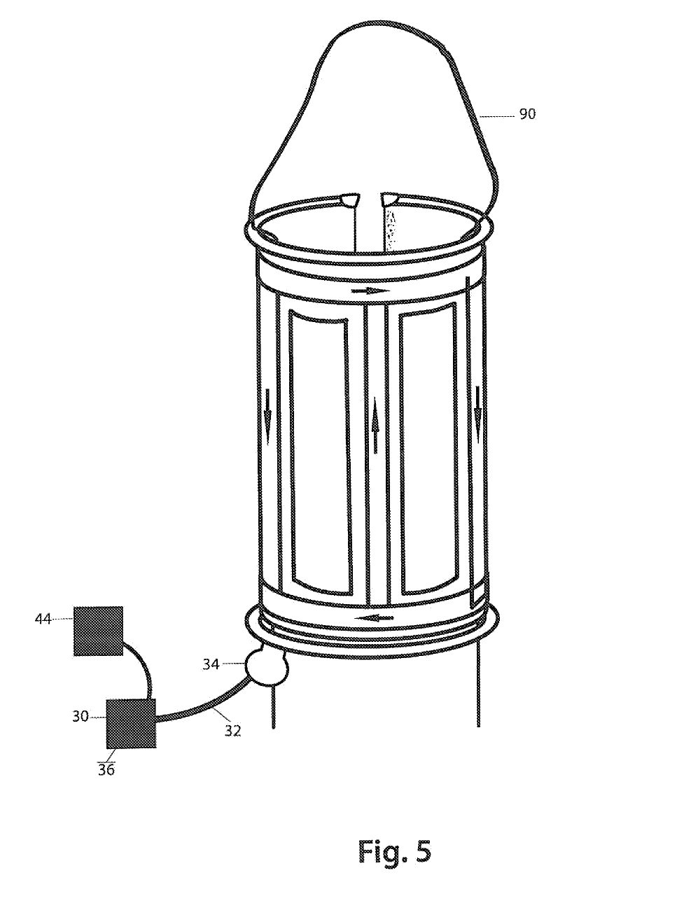

FIG. 5 shows an alternate embodiments in which additional enhancement members are attached to the body, in the form, for example of a plurality of flexible filaments 90.

FIG. 6 A,B,C shows an alternate embodiment in which one method of connecting (JB inter-locking hook 6A-91 and 6C-91a-91b)) the edges (6A-20,22) of body (6B-12), incorporating the shown infused plurality of expanded air-chambers (6B-92,93) and an extension of the body (12) to incorporate an integral thumb-pump.

In other words, body 12 forms penile cuff generating a pressure when donned, said pressure being adjustable and programmable based in the operation of the pump 30 and the previous determination of the coefficients of elasticity of the underlying substrate and the durometer of the substrate. In the event that two different substrates are used of different elasticity and durometer then the direction of expansion caused by the infused fluid is further controlled and may, therefore, expand differentially inwardly toward the penis than outward toward the walls of the vagina. (Instead of a pump with an electric motor, other sources of a suitable fluid may be provided, including a precharged canister (air pellet) or a chemical fluid source, etc.) The cuff encircles the shaft of a penis, and has an open distal end 50 and an open proximal end 52, said open distal end and open proximal end defining a length of the cuff there between, wherein the cuff, composed of dielectric polymeric material. Alternatively the material may be elastomeric and may be natural rubber latex or silicone rubber. The material is preferably adapted to extend longitudinally along at least a portion of the shaft of said penis, said cuff comprising at least one layer but may comprise several different layers of various stiffness so that the interior volume of any or all said individuated parts may be individually inflated or inflated in unison or in a segment by segment manner forming at any one time and individual or a plurality of longitudinally aligned and laterally aligned and interconnected passages in relationship to one another. Valves 34 and 38 are used to introduce an inflation fluid into the interior volume and inflatable interconnected passages or tubes 16.

The pressure of the fluid is controlled such that in one embodiment the introduced fluid exerts compressive pressure on the shaft of the penis or exerting a series of compressive and releasing movements that would be interpreted to be similar to jerking or rubbing the shaft as would be experienced during coitus or masturbation. For this purpose, in one embodiment, an electronic controller 44 is provided that is programmable and is connected to the pump 30 or other an adjustable liquid/air infusion source for selectively inflating and deflating body 12. When inflated/deflated the body reflexively applies selective pressure which may also be interpreted as a twisting or wringing sensation to a penis of a male wearer.

The compression and perceived movement is achieve by a combination of applied energy from the articulating pump that can both infuse and exhaust air/fluid and by its ability to deliver variable pressure over variable intervals. Furthermore, the action of the pump may be enhanced and further controlled by the placement of open-able and close-able flapper valves within the tubule network itself.

The body 12 can be made of several layers, each of the layers being made from distensile or non-distensile polymer substrates and may vary in thickness form 0.02-2.0 mils with a durometer value of 30 A to 70 A and, where distensile, having a modulus of elasticity of at least 50% elongation, with a range of psi of from 50-200.

The basic shape and configuration of the body 12 can be constructed roughly following heat-sealing or seam joining techniques or adhesive technology commonly known and used in the art for forming structural articles from polymeric film materials in the form of web or sheet stock.

The body can be made by some of the techniques disclosed in Kassman U.S. Pat. Nos. 5,885,205 and 6,569,083 which both discuss a single multi-laminate structure into which component segments that are integrally introduced via any joining technique. The lamina of the inflatable cuff of the present invention can be joined by a suitable welding technique such as RF welding, heat impulse welding, solvent welding, adhesive bonding, etc. It is also possible to join the respective layers of the structure by adhesive bonding or any other suitable joining means and methods. Preferably, heat impulse welding or RF welding is employed, with RF welding being most preferred. The sealable interior volume of the inflatable cuff may have any suitable volume appropriate to its use. In one embodiment, the interior volume can have an interior inflated volume in a range of from not less than 0.05 liter at not less than 1 psi. Tubes may be infused to as much as 200 psi of fluid will be recognized that the inflated volume of the cuff compartment will depend on the pressure to which the compartment is inflated, and the extensibility or expandable character of the compartment. In the case of elastomeric or elastic materials of construction, the volumetric expansion of the cuff inflation compartment may be significant.

The seams of the inflatable cuff themselves must be manufactured in a manner so that the seal point or points are continuous along their length, to provide the requisite fluid-leak-tightness for the product article in the inflated condition. Preferred seam characteristics for polyurethane materials of the above-described types, include a seam dimension that is in a range of from about 0.010 to 0.50 inch, and most preferably in a range of from about 0.050 to about 01.125 inch.

In preferred practice, the seam strength of the inflatable cuff should be at least about 1000 pounds per square inch (psi), or alternatively at least about 30% of the strength of the un-welded film. In a preferred aspect, the penile cuff is fabricated so that it does not slip along the shaft of the penis once properly locked and installed. In alternate embodiments and, possibly, as an option in the preferred embodiment a layer of medical grade detachably-attached (on the side facing the penis) film such as MSX-6690 or MSX-6471 (3M Company) may be applied to at least one portion of the inside of body 12 to prevent slippage. This non-slip character can also be achieved by applying a skin-bonding spray adhesive to the shaft prior to cuff positioning. Alternatively, the inner layer may be manufactured in a slip-resistant configuration or using a modulus elastomer whose surface characteristics had been previously demonstrated to be highly frictional to human skin. For example, the inner layer of the inflatable cuff may be comprised of a nonslip waterproof fabric, such as expanded polytetrafluoroethylene (ePTFE), as described in Crawley, et al., U.S. Pat. No. 5,948,707. Alternatively, the inner layer film may be chemically or physically modified on its skin-contacting surface to impart slip-resistance characteristics, by surface treatment such as ionization treatment, chemical etching, abrasion techniques, texturizing techniques, surface application of tackifiers, etc.

In one embodiment, a hand pump is used to infuse air or a fluid connected internally from an internal or external source to the hand pump. Alternatively, fluid may be infused via an internal thumb-pump which is activated by pressing an integrally formed sponge/foam bladder that is automatically refilled with ambient environmental air-pressure or from an enclosed bladder operating through a one-way check (anti-reflux) valve. In this manner, the requisite volume of inflation air can be introduced into the interior volume of the cuff. By integrating the hand pump with an inflatable cuff, the unitary device is easy to operate and can be selectively and serially inflated as required. Alternatively, a variable-adjustably powered pump may infuse and manipulate the ‘pumping action’ through the control of a programmable switch.

Among polymeric film materials useful in the broad practice of the present invention to form the inflatable cuff and the valve, illustrative materials include: polyurethane; polyisoprene; styrene-isoprene, styrene/styrene-butadiene-styrene compositions, such as Kraton® polymers (commercially available from Shell Chemical Company, Houston, Tex.); polyvinylchloride (PVC) that has been plasticized to the desired flexibility and hand characteristics; urethane/PVC blends; urethane that has been plasticized to the desired flexibility and hand characteristics; Covale™ polymer (commercially available from Dow Chemical Company, Midland, Mich.); polyester elastomers such as HytreL®. (commercially available from E.I. DuPont de Nemours Company, of Wilmington, Del.); polyamide elastomers such as Pebax® (commercially available from Atochem), olefinic polymers (polypropylene, polyethylene, etc.); and metallocene polymers.

A preferred polymeric film material is polyurethane film having a durometer not exceeding about 90 A.

The polymeric film material used to fabricate the inflatable cuff may be used in the form of a blown film, extruded sheet, solvent cast film or other suitable web stock formed of the polymeric material. In addition to the aforementioned polymeric materials, the inflatable cuffs of the invention may be formed of any other suitable materials, natural or synthetic, that in native form or as treated by suitable treatment methods, possess a sufficiently low gas permeability to be useful for their intended purpose, as regards the maintenance of the inflated condition for the desired duration.

The thickness of the polymeric film material used to form the inflatable cuff of the invention, in a preferred aspect, is typically in a range of from about 1 to about 25 mils, more preferably in a range of from about 2 to about 10 mils, and most preferably in a range of from about 2 to about 8 mils. In any of the embodiments two different types of elastomeric substrates may be welded together and, an embodiment is envisioned where one of the substrates is elastomeric and the other, while dielectric, is not elastomeric.

The polymeric film from which the inflatable cuff is fabricated can contain dye or pigment additives to impart a desired color to the product structure, and the resins from which the films are formed may be blended with other additives, such as tackifiers, antioxidants, uv stabilizers, dispersing agents, fillers, surfactants, surface modifiers, heat stabilizers, flame retardants, antimicrobial agents, etc., as necessary or desirable to the end use of the inflatable cuff. The sheet stock used to fabricate the inflatable cuff can also contain conductive material, e.g., carbon black or metallic particulate materials, to impart conductivity characteristics to the cuff, if desired in a specific end use application of the invention.

The tubes 16 can range from > 1/16″ to ¾″ “in diameter to define a tube network extending approximately ⅛″ from either open end of the invention. The tubes 16 are interconnected to at least ¼″” similar equally spaced longitudinal and circumferential channels which extend approximately to cover the entire surface of the body. In addition, pockets maybe formed between and connected to the tubes. The tubes and pockets may be injected (or pressurized temporarily or permanently with the same or different fluid or even a rheopathic substance that may have been activated through touching to produce heat (but not more than 96 degrees F.). Specifications:

Average pressure to fill to “rigid/firm”: 2.5 psi;

Average burst pressure: 8.5 psi.

Circumferential/longitudinal compressive pressure total: at least 1.5 foot lbs @ at least 1.75 psi.

Air infusion is caused by depressing the squeeze bulb and is further controlled through a one way membrane regulator/check valve. The designed inward pressure (approximately) 6.45 ft/lbs created when the circumferential tubes expands exerting compressive pressure on the base of the penis and reduces venous leaks thus supporting the erectile process. The thumb-pump will exert similar pressures and expansion.

The present invention provides a means of supporting and sustaining and augmenting an erection and to deliver more stimulation to the penis and to the tissues of the vagina. The invention includes a sleeve that fits around and is adjusted to the penis by manipulating an over-wrap extension and securing the two edges of the penile sleeve together by finding the optimal (secure-tight) position and pressing the Velcro® hook end into the Velcro® loop end or by interconnecting the special JB—hook system or by peeling a protective layer of a double-sided tape away from either or both and sticking edges 20,22 together. Alternatively in the sleeve configuration embodiment, the device may be either lowered onto a penis, or rolled onto the penis, or, alternatively, the penis may be threaded into the sleeve if it is fully flaccid. Once the head of the penis is exposed and the invention is on the shaft of the penis the infused pressure causes the expansion of the inner surfaces of the device against the outer skin of the shaft of the penis causing the device to be maintained in place as a result of the friction created by the expanding walls of the device against the shaft.

An embodiment of either the wrap or the sleeve configuration is envisioned where a layer of at least semi-rigid (durometer Shore D/50) stays are placed in a layer between two polymer substrate device layers in a manner and configuration aligned with the penile shaft that will safely add lateral stability and rigidity to the invention and therefore to the penis wrapped by the invention. The at least one of such semi-rigid means may be made from hard rubber or plastic and would be at least ⅛″ wide, at least 1″ long, and at least 1/32″ thick.

Once the sleeve is secure on the penis, air or fluid is infused from any infusion source or the infusion source may be connected to the sleeve, which already is at least partially filled with air or fluid. Alternatively, the fluid or at least 5% of the fluid may be drawn from a reservoir in or near to the pump. In one embodiment, at least one and as many as three different fluids may be variously pumped into the invention using separate tubule channels. It is also envisioned that two different fluids may be introduced into the same channel because each fluid is likely to have a different coefficient of compressibility and therefore, when introduced into a finite tubule or chamber length or size will act to expand that tubule's/chambers external walls differentially. Once the air infusion source is removably secured to the sleeve by either pressing on the infusion source or by turning its internal battery on, the source in combination with the network of infusion tubes and/or valves within the tubes work in tandem to change the pressure in the tubes. Such change in pressure, achieved by any form of cycling of the pressure within the chambers/tubules or by the on-off infusion of the air/fluid source causes perceived movement in the invention sleeve.

Alternative to the rapid cycling on-off of the infusion source is the ability of the infusion source to deliver more or less pressure by specific adjustment of its power source through a potentiometer or a programmed electronic circuit or by varying the diameter of the main infusion channel. The drawings show a series of directional arrows to indicate the movement of the air or fluid in the infusion network. Similarly, the use of two primary insertion tubes leading form the articulating pump are to show the capacity of the invention to cause movement. Additionally, the location, shape, construction, and material (polyurethane scrim with ‘hairy’ interior (proximal to the glans) surface for maximum friction) of the ‘Excitement Enhancer’ will create further stimulation for both sexual partners.

In the preferred embodiment of the invention, the tube network and articulating pump may be set to adjustably achieve as near as possible to the feeling of a person's hand placed on the penis with the hand then moving and manipulating the stroking of the penis in a conventional ‘jerking’ motion that many men use while masturbating. Similarly, once the device is placed on the penis and the penis is inserted normally as it would for intercourse into a woman's vagina, the invention device is perceived to stimulate the vagina and/or the exterior membranes of the vulva in a manner used by women during masturbation. The device would be able to achieve the same stimulation to a female if it were mounted onto a dildo or any other ordinarily static sexual device that could be used for masturbation.

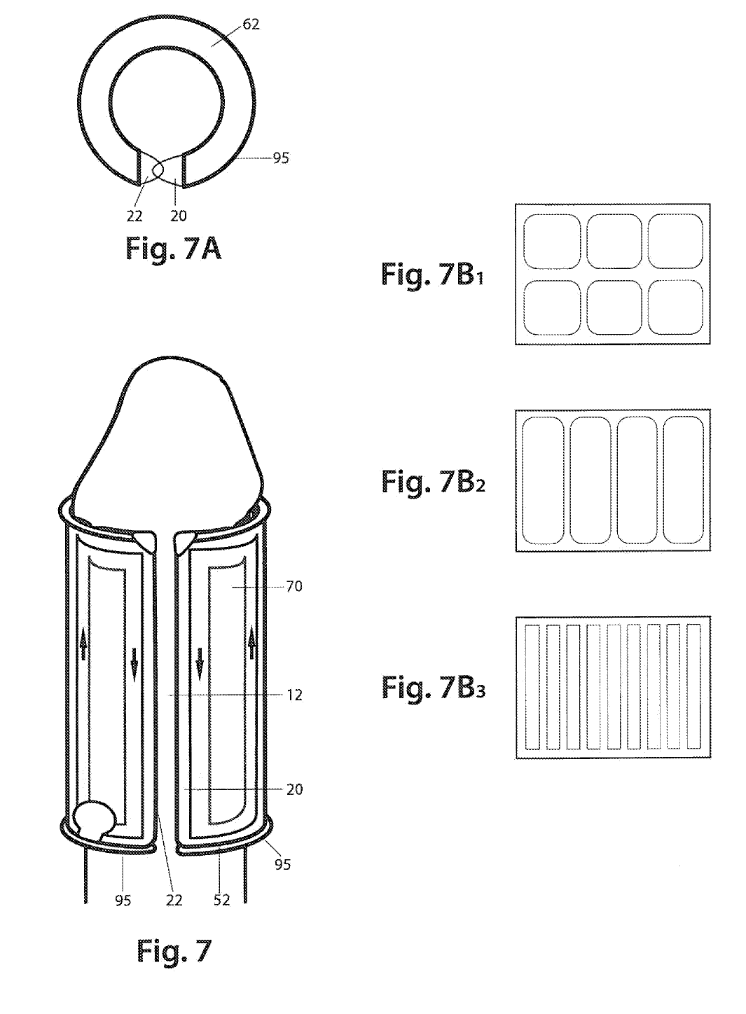

In another embodiment of the invention shown in FIGS. 7, 7A, 7B1, 7B2, and 7B3, a sealable pocked is created in body (12) whose length is determined by the size of an insert (7B1,2,3). The pocket is in the proximal end and may extend up to the proximal end and be as many degrees of the arc or the body (12) as determined needed for it to fit. Each of the different insert that may either be flat or pre-shaped into a semi-circle so as to acclimate them approximately to the shape of the shaft of the penis, will be designed with their own inflatable or fillable pockets, chambers, tubules with any type of liquid that may expand the insert in such a manner as to reflexably affect the laminates of body 12 and, when positioned on the penis, be of an effect that transfers such expansive and/or compressive energy to the penis itself and even, possibly to the walls of the vagina. The manner of inflation will be similar to that of the invention itself and may be the same or different or totally independent.

Furthermore, such network of fillable spaces may be filled by a fluid or chemical that is rheopexic. Additionally, such network may be filled with a substance that is interactive with another similarly filled chemical so that upon either the activation by either normal body heat, by body movement during coitus, or by any prior manipulation of the chambers that begin the reaction, such reaction is such that the substance in the tubules begin to harden in such a manner that the hardness provides additional support and stimulation for the man and for his partner as well.

The invention works through the use of a uniquely designed penile support sleeve and a variable/detachable air infusion source to form a system that is designed not only to support and maintain erections but, working together, provides added stimulation and support for increased pleasure and satisfaction.

Numerous modifications may be made to the invention without departing from its scope as defined in the appended claims.

I claim:

1. A palliative device comprising:
a body sized and shaped to form a sleeve extending at least partially longitudinally along the length of a penis when donned, said body including a plurality of cavities, said chambers being in fluid communication with a fluid inlet; and
a fluid source in communication with said fluid inlet and being adapted to selectively pressure and/or depressurize said chambers to apply corresponding forces on the penis.

2. The device of claim 1 wherein said cavities include a plurality of tubes extending circumferentially and longitudinally through said body.

3. The device of claim 2 further comprising chambers disposed and in fluid connection with said tubes.

4. The device of claim 3 wherein said chambers are arranged in a two dimensional array on said body.

5. The device of claim 3 wherein each said chamber extends longitudinally, said chambers being arranged circumferentially around the penis.

6. The device of claim 1 further comprising a switching element selectively activating said fluid source.

7. The device of claim 6 wherein said switching element selectively pressurizes and depressurizes said chambers.

8. The device of claim 1 wherein said fluid source is a pump adapted to pump a fluid into said chambers.

9. The device of claim 1 wherein said fluid source is a pressurized tank.

10. The device of claim 1 wherein said fluid is air.

11. The device of claim 1 wherein said fluid is a liquid.

12. A palliative device comprising:
a body arranged and constructed to fit and extend longitudinally on a penis, said body having two longitudinal edges; and
securing members constructed to secure said edges together to form a longitudinal sleeve on said penis.

13. The palliative device of claim 12 wherein said securing members are interlocking hook and loop members.
